(19) United States
(12) Patent Application Publication
(10) Pub. No.: US 2015/0154025 A1
(43) Pub. Date: Jun. 4, 2015

(54) INFORMATION PROCESSING APPARATUS AND METHOD

(71) Applicant: FUJITSU LIMITED, Kawasaki-shi (JP)

(72) Inventor: Yoichi Tanimura, Kawasaki (JP)

(73) Assignee: FUJITSU LIMITED, Kawasaki-shi (JP)

(21) Appl. No.: 14/483,580

(22) Filed: Sep. 11, 2014

(30) Foreign Application Priority Data
Dec. 2, 2013 (JP) 2013-249556

(51) Int. Cl. G06F 9/30

(52) U.S. Cl. CPC G06F 9/30145

(57) ABSTRACT

In a multi-cluster system in which a plurality of second information processing apparatuses are connected to a first information processing apparatus including a shareable storage device, any one of the first and the second information processing apparatuses includes: a receiver unit configured to receive version_number_information from the first and the second information processing apparatuses in each of which a first execution environment where a first program is executable is effective, the version_number_information indicating a version number of a second program in a second execution environment is executable; and an instruction unit configured to transmit a switch instruction to the first and the second information processing apparatuses, the switch instruction giving an instruction to switch the first execution environment to the second execution environment, if the version numbers in the version_number_information received from all the first and the second information processing apparatuses match each other.

### CROSS-REFERENCE TO RELATED APPLICATION

This application is based upon and claims the benefit of priority from the prior Japanese Patent Application No. 2013-249556 filed on Dec. 2, 2013, the entire contents of which are incorporated herein by reference.

### FIELD

The embodiments discussed herein are related to update of software.

### BACKGROUND

For upgrading a version of software in a multi-cluster system which operates with multiple clusters operating cooperatively, the consistency of the software versions has to be maintained across the apparatuses constituting the system. For version-upgrade of software, there are first and second techniques described below.

In the first technique, a system is provided with main and sub management servers in addition to data servers. The main management server manages data access from clients to the data server during normal operations. In a version-upgrade of software, the version of the software in the sub management server is upgraded firstly, and then, after completion of the version-upgrade of the software in the sub management server, those of the data servers and the clients are version-upgraded one after another. The data servers and clients having completed the version-upgrade are put under the control of the sub management server having completed the version-upgrade. The data servers and clients before the version-upgrade are put under the control of the main management server that is not completed the version-upgrade. In this way, a normal operation can be continued even during the version-upgrade (see Japanese Laid-open Patent Publication No. 11-353202).

In the second technique, a management server provided with an information processing system includes a receiver unit that receives a version-upgrade instruction to upgrade a version of software stored in servers. In addition, the management server includes a version-upgrade unit that halts a certain one of multiple servers and upgrades the version of the software stored in the halted server when the receiver unit receives a version-upgrade instruction.

Further, the management server includes a control unit that upgrades the version of the software stored in all the severs by causing the version-upgrade unit to perform operation for halting and version-upgrade on all the servers one after another (see Japanese Laid-open Patent Publication No. 2008-250427).

Multiple information processing apparatuses and storage devices constituting a multi-cluster system each run respective firmwares, and all closely cooperate with each other to operate as a multi-cluster. Therefore, if there is a functional difference even transitionally among the firmwares in the apparatuses, the apparatuses may fail to ensure operations as the multi-cluster system. In order to avoid even transitional inconsistency among the firmwares across the apparatuses during version-upgrade of the firmwares, currently, the version upgrade is performed after the system is halted. However, there is a demand that the version-upgrade be accomplished without halting the system.

Under these circumstances, an aspect of the present disclosure has an object to provide a system capable of performing a version-upgrade of a software program without halting a multi-cluster system while maintaining the consistency of the software program across apparatuses included in the multi-cluster system.

### SUMMARY

According to an aspect of the invention, in a multi-cluster system in which a plurality of second information processing apparatuses are connected to a first information processing apparatus including a shareable storage device, any one of the first and the second information processing apparatuses includes: a receiver unit configured to receive version number information from the first and the second information processing apparatuses in each of which a first execution environment where a first program is executable is effective, the version number information indicating a version number of a second program in a second execution environment is executable; and an instruction unit configured to transmit a switch instruction to the first and the second information processing apparatuses, the switch instruction giving an instruction to switch the first execution environment to the second execution environment, if the version numbers in the version number information received from all the first and the second information processing apparatuses match each other.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 illustrates one example of a configuration of an information processing apparatus according to a present embodiment;

FIG. 2 illustrates one example of a configuration of a multi-cluster system according to the present embodiment;

FIG. 3 illustrates one example of configurations of a managing apparatus and a managed apparatus according to the present embodiment;

FIG. 4 illustrates one example of a data structure of HLC version number management information;

FIG. 5 illustrates one example of a data structure of HLC execution status information;

FIG. 6 illustrates one example of a state before a version-upgrade in the multi-cluster system according to the present embodiment;

FIG. 7 is a diagram for explaining an operation in activating a new-version HCP in an SSU#1 from the state illustrated in FIG. 6;

FIG. 8 is a diagram for explaining an operation of new-version HCP activation processing for a cluster#0 after completion of the new-version HCP activation processing for the SSU#0 and a cluster#1;

FIG. 9 is a diagram for explaining an operation in activating the new-version HCP in the cluster#0 from the state where switch completion notifications are received;

FIG. 10 is a flowchart illustrating processing contents of a version-upgrade in the entire multi-cluster system according to the present embodiment;

FIG. 11 is a flowchart illustrating detailed processing contents of a version-upgrade in a version number adjustment unit and a version number switch unit in the multi-cluster system according to the present embodiment; and

FIG. 12 is a flowchart illustrating detailed processing contents of a version-upgrade in the version number adjustment unit of the managing apparatus and the version number switch unit (last) in the multi-cluster system according to the present embodiment.

### DESCRIPTION OF EMBODIMENTS

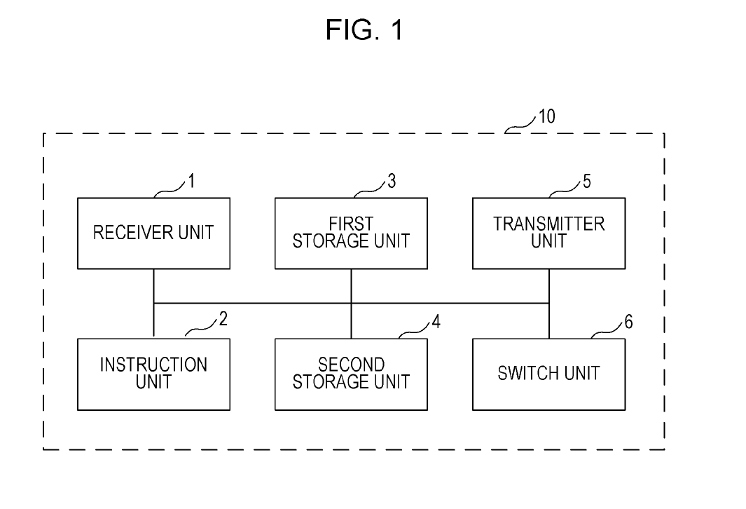

FIG. 1 illustrates one example of a configuration of an information processing apparatus according to an embodiment. In FIG. 1, an information processing apparatus 10 is any of first and second information processing apparatuses in a multi-cluster system in which the second information processing apparatuses are connected to the first information processing apparatuses each including a sharable storage device. The information processing apparatus 10 includes a receiver unit 1, an instruction unit 2, a first storage unit 3, a second storage unit 4, a transmitter unit 5, and a switch unit 6.

The receiver unit 1 receives version number information from the first and second information processing apparatuses in each of which a first execution environment where a first program is executable is effective. The version number information indicates a version number of a second program in a second execution environment where the second program being a modified version of the first program is executable.

When the version numbers in the version number information received from all the first and second information processing apparatuses included in the multi-cluster system match each other, the instruction unit 2 transmits a switch instruction to switch the first execution environment to the second execution environment to the first and second information processing apparatuses.

The first storage unit 3 stores the first program. The second storage unit 4 stores the second program.

The transmitter unit 5 transmits the version number information to any of the first and second information processing apparatuses in the multi-cluster system.

The switch unit 6 switches the first execution environment to the second execution environment if the switch instruction is received from any of the first and second information processing apparatuses in the multi-cluster system. Here, the switch unit 6 switches the first execution environment to the second execution environment only if the first program is not running.

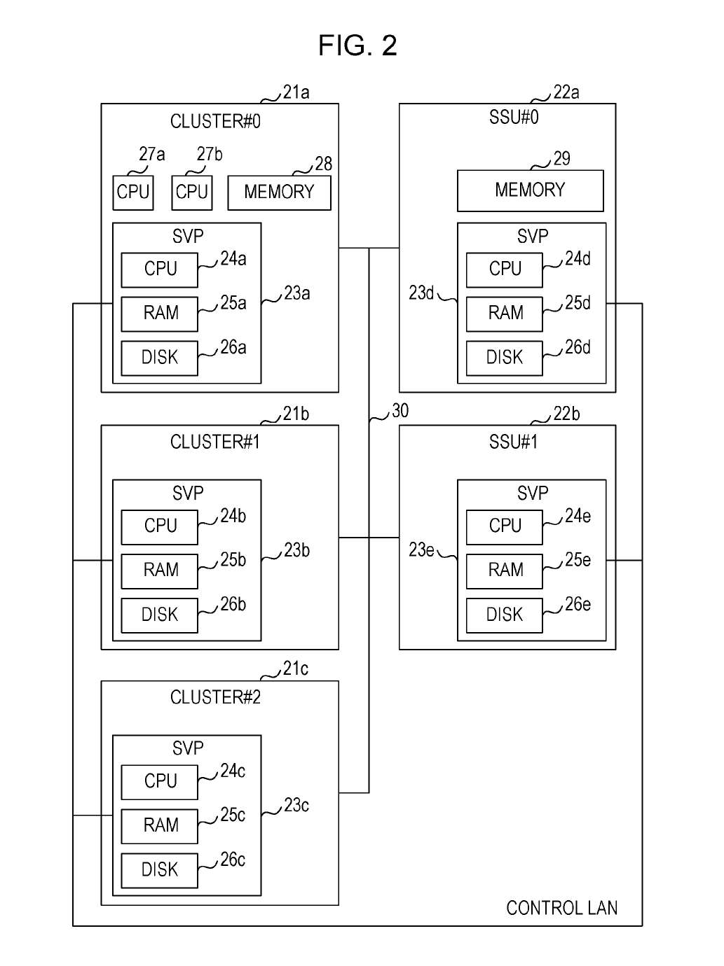

FIG. 2 illustrates an example of a configuration of the multi-cluster system according to the present embodiment. The multi-cluster system includes a cluster#0 (21a), a cluster#1 (21b), a cluster#2 (21c), a SSU (system storage unit)#0 (22a), and a SSU#1 (22b). The cluster#0 (21a), the cluster#1 (21b), the cluster#2 (21c), the SSU#0 (22a), and the SSU#1 (22b) are connected to each other via a bus or network 30. In the following description, the cluster#0 (21a), the cluster#1 (21b), and the cluster#2 (21c) are also simply referred to as a cluster 21 when not particularly distinguished from each other. Similarly, the SSU#0 (22a) and the SSU#1 (22b) are also simply referred to as an SSU 22 when not particularly distinguished from each other. In addition, the clusters 21 and the SSUs 22 included in the multi-cluster system are also simply referred to as apparatuses collectively.

The cluster 21 is an information processing apparatus connected to the SSUs 22 and configured to make data read and write requests to the SSUs 22. The cluster#0 (21a), the cluster#1 (21b) and the cluster#2 (21c) share the SSU#0 (22a) and the SSU#1 (22b). Each cluster 21 includes one or more CPUs 27a, 27b and a memory 28. The CPUs (central processing units) 27a, 27b execute various kinds of processing by using the memory 28. Note that, as similar to the cluster#0, the cluster#1 and the cluster#2 also include CPUs and memories which however are omitted in FIG. 2.

The SSUs 22 are multiplexed storage devices shared by the multiple clusters 21. Each SSU 22 receives data read and write requests from the clusters 21, executes data read and write processing, and returns the obtained result to the clusters 21. The SSU#0 (22a) and the SSU#1 (22b) may store data redundantly. Data written from the clusters 21 is stored in a memory 29. Note that, as similar to the SSU#0, the SSU#1 also includes a memory which however is omitted in FIG. 2.

The clusters 21 and the SSUs 22 include service processors 23a to 23e, respectively. In the following description and the drawings, the service processors 23a to 23e are referred to as SVPs 23a to 23e. In addition, in the following description, the SVPs 23a to 23e are simply referred to as SVPs 23 when not particularly distinguished from each other.

The SVPs 23a to 23e include CPUs 24a to 24e, RAMs (random access memories) 25a to 25e and disks 26a to 26e, respectively. In the following description, the CPUs 24a to 24e, the RAMs 25a to 25e and the disks 26a to 26e are simply referred to as the CPUs 24, the RAMs 25, and the disks 26, respectively, when not particularly distinguished from each other. The SVPs 23a to 23e are connected to each other via a control LAN. Here, the disk 26 may be a semiconductor memory such as a flash memory.

As one example, the CPU 24 implements the functions of the receiver unit 1, the instruction unit 2, the transmitter unit 5 and the switch unit 6. The disk 26 is one example of the first storage unit 3 and the second storage unit 4.

Each SVP 23 executes firmware such as a hardware control program (HCP), for example. The SVP 23 controls and monitors hardware such as the CPUs 27 and the memory 28 constituting the cluster 21 and the memory 29 and the like in the SSU 22, for example. The apparatuses constituting the multi-cluster system mutually perform such control and monitoring via the dedicated control local area network (LAN). Moreover, for the monitoring, the apparatuses use control commands, such as high level commands (HLCs), for example, which are exchanged among the apparatuses. In other words, an HLC is a command functioning as an interface to control communications between the SVPs of the multiple clusters 21 and SSUs 22 included in the multi-cluster system. HLCs are loaded on a module basis from the disk 26 to the RAM 25 by the CPU 24, and the HLCs loaded to the RAM 25 are executed at various timings by the CPU 24. The HCP is read from the disk 26 to the RAM 25 and executed by the CPU 24. In the following description, loading HLCs from the disk 26 to the RAM 25 is simply referred to as loading.

If the version number (version) of the HCP running in the SVP 23 is changed, the version numbers (versions) of one or more HLCs are accordingly changed in some cases. If the version-upgrade of the HCP on online makes a modification involving specification change of an HLC, inconsistency may possibly occur on the HLC which is the interface used in communications between the clusters 21 and the SSUs 22. For example, let us consider an operation which the multi-cluster system in FIG. 2 performs for a HCP version upgrade in all the clusters 21 and the SSUs 22 included in the multi-cluster system. In this case, if the apparatuses perform the HCP version-upgrade one after another, for example, starting from the cluster#0 (21a), a situation may occur where a cluster (for example, the cluster#0 (21a)) having an HLC in an upgraded version and an SSU 22 having the HLC in the not-upgraded version coexist for a certain time period during the version-upgrade work of the entire system. In this situation, if the cluster 21 after the version-upgrade and the SSU 22 before the version-upgrade perform communications therebetween, an error may possibly occur due to a difference in the HLC version number between the apparatuses performing the communications.

To address this, the multi-cluster system according to the present embodiment provides a scheme for reducing the occurrence of a situation having HLC inconsistency between the apparatuses included in the multi-cluster system during HCP version-upgrade work involving an HLC specification change.

Specifically, the multi-cluster system according to the present embodiment reduces the occurrence of an HLC inconsistency situation by performing timing control such that all the apparatuses included in the multi-cluster system can simultaneously switch an HLC in an old version to the HLC in a new version. To this end, the apparatuses are each provided with an installation area where the new-version HCP is to be installed, in addition to an area where the currently-running HCP (the old-version HCP) is stored. Installation work of the new-version HCP is performed on the newly-provided installation area. Here, this installation work is done while the old-version HCP is running. In some cases, the installation work of the new-version HCP may include generating the new-version HCP by applying an update program (patch) to the old-version HCP, and storing the generated new-version HCP into the installation area. Then, in an event of activating the new-version HCP, each of the apparatuses checks HLC states in the installation areas of all the apparatuses included in the multi-cluster system. As a result of the checking, if it is judged that the new-version HLC is not confirmed as operable in any of the apparatuses included in the multi-cluster system, the apparatus activating the new-version HCP loads the old-version HLC for the HLC not confirmed as operable. Then, when it is confirmed that all the apparatuses included in the multi-cluster system can switch to the new-version HLC, the switching to the new-version HLC is performed in the apparatuses.

In this way, after it is confirmed that all the apparatuses included in the multi-cluster system can load the new-version HLC, the switching to the new version is performed at one time. Thus, the occurrence of an HLC inconsistency situation can be reduced.

Moreover, HLC switching in the present embodiment is done only after it is confirmed that an HLC to be switched is not running. This reduces a failure that may occur due to switching of a currently-running HLC.

In addition, since a HLC switch instruction is transmitted to the clusters and SSUs in operation, the HLC switch instruction may compete with an instruction which may be issued from the operating system (OS) in each of the apparatuses. To address this, the availability of a scheduler execution right (a right to execute configuration control) to the OS instruction is set to a busy status, and thereby the OS is requested to retry the instruction. In this way, a failure that would occur due to a competition with an OS instruction can be reduced.

In some parts of the following description, the HCP before version-upgrade work is referred to as the old-version HCP, and the HCP after the version-upgrade work is referred to as the new-version HCP. In addition, the SVPs 23 of the apparatuses perform communications therebetween by using multiple HLCs. The following description is provided on the assumption that the version numbers of one or more of the HLCs will be updated along with the version-upgrade of the HCP. That is to say, the version numbers of one or more of the multiple HLCs used in the SVPs 23 are updated after the version-upgrade work. In the following description, an HLC whose version number is updated in the version-upgrade work is referred to as a version-upgrade target HLC.

The multi-cluster system in the present embodiment includes a managing apparatus 31 configured to provide a function to control a timing of switching each HLC, and a managed apparatus 32 configured to receive a switch instruction for an HLC from the managing apparatus 31 and to switch the HLC. Any one of the apparatuses included in the multi-cluster system has the function of the managing apparatus 31, and the other apparatuses act as the managed apparatuses 32. For example, in FIG. 2, the SSU#0 may act as the managing apparatus 31, and the other apparatuses, namely the cluster#0, the cluster#1, the cluster#2, and the SSU#1 may act as the managed apparatuses 32.

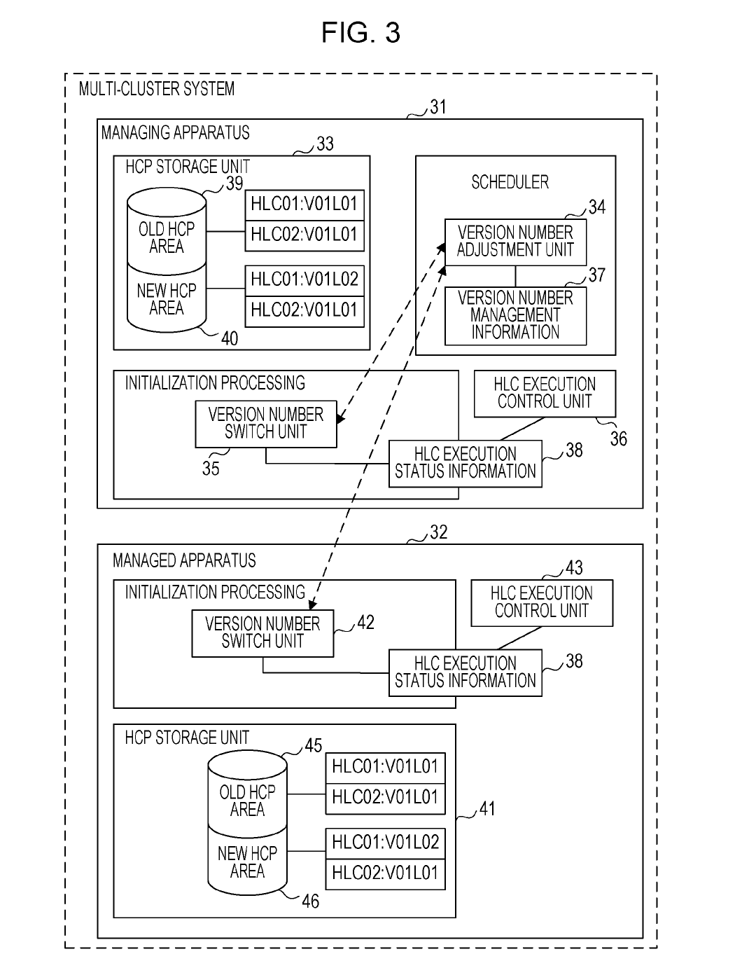

FIG. 3 illustrates one example of configurations of the managing apparatus 31 and the managed apparatus 32 according to the present embodiment. The multi-cluster system includes one managing apparatus 31 and multiple managed apparatuses 32.

The managing apparatus 31 includes an HCP storage unit 33, a version number adjustment unit 34, a version number switch unit 35 and an HLC execution control unit 36. Part or all of functions of the version number adjustment unit 34, the version number switch unit 35 and the HLC execution control unit 36 is provided by the CPU 24. Part or all of functions of the HCP storage unit 33 is provided by the disk 26.

The HCP storage unit 33 is a storage area where data of the HCP and the HLCs are stored. The HCP storage unit 33 includes an old HCP area 39 and a new HCP area 40. The old HCP area 39 is an area for storing the old-version HCP and HLCs. The new HCP area 40 is an area for storing the new-version HCP and HLCs. Before the version-upgrade work, the managing apparatus 31 loads the HCP and HLCs stored in the old HCP area 39, and operates under the loaded HCP and HLCs. The new-version HCP and HLCs are installed in the new HCP area 40.

The version number adjustment unit 34 controls the timings of switching HLCs in all of the apparatuses included in the multi-cluster system. The version number adjustment unit 34 may be implemented as part of processing of a scheduler (processing having a right to perform overall configuration control of the multi-cluster system).

To be specific, the version number adjustment unit 34 firstly receives version number notifications from the version number switch unit 35 of the managing apparatus 31 and all the managed apparatuses 32. Here, the version number notification includes the version number information of the new-version HCP and the version number information of each new-version HLC stored in the new HCP area of each apparatus. As described later, as similar to the managing apparatus 31, the managed apparatus 32 also includes a HCP storage unit, and the HCP storage unit includes an old HCP area and a new HCP area. When receiving the version number information of the HLCs, the version number adjustment unit 34 stores the received version number information into HLC version number management information 37 for managing the version numbers of the HLCs. Incidentally, although the above description states that the version number notification includes the version number information of the new-version HCP and the version number information of each new-version HLC stored in the new HCP area of each apparatus, the version number notification does not have to include the version number information of the new-version HCP, or may include the version number information of the HCP and HLCs stored in the old HCP area.

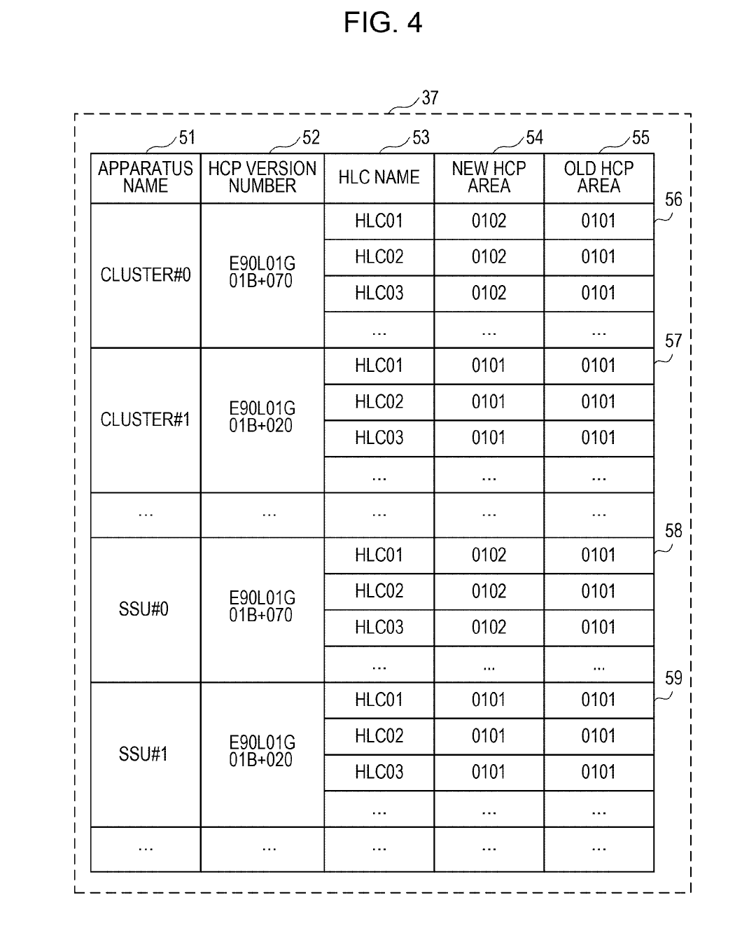

FIG. 4 illustrates one example of a data structure of the HLC version number management information 37. In FIG. 4, the HLC version number management information 37 includes data items of an apparatus name 51, an HCP version number 52, an HLC name 53, a new HCP area 54 and an old HCP area 55. The apparatus name 51, the HCP version number 52, the HLC name 53, the new HCP area 54 and the old HCP area 55 are associated with each other in each record.

The apparatus name 51 is identification information to uniquely identify each of the apparatuses included in the multi-cluster system. The HCP version number 52 is information indicating the version number of the HCP to be operated on the SVP 23 in the apparatus indicated by the apparatus name 51. The HLC name 53 is identification information to uniquely identify each of HLCs to be operated in the apparatus indicated by the apparatus name 51. The new HCP area 54 is information indicating the version number of the HLC indicated by the HLC name 53 and stored in the new HCP area in the apparatus indicated by the apparatus name 51. The old HCP area 55 is information indicating the version number of the HLC indicated by the HLC name 53 and stored in the old HCP area in the apparatus indicated by the apparatus name 51. Here, the HLC version number management information 37 is stored in a predetermined storage area in the disk 26 of the SVP 23 or the like.

After storing the contents of the received version number notifications into the HLC version number management information 37, the version number adjustment unit 34 judges whether or not the version number notifications each indicating that the new-version HCP (and HLCs) is stored in the new HCP area have been received from all the apparatuses included in the multi-cluster system. In other words, this is processing of judging whether all the apparatuses included in the multi-cluster system have completed the installation work of the new-version HCP, and thus become switchable to the new version. In the following description, among the version number notifications, a version number notification particularly indicating that the new-version HCP (and HLCs) is stored in the new HCP area is referred to as a new version storage notification.

The version number adjustment unit 34 judges whether or not a new version storage notification is received by referring to the value of the new HCP area 54 in the HLC version number management information 37. Specifically, if the value in the field of the new HCP area 54 of a record having a version-upgrade target HLC in the HLC name is the version number of the new version, the version number adjustment unit 34 judges that the new version storage notification is received from the apparatus indicated by the apparatus name 51 of the record. Accordingly, the version number adjustment unit 34 firstly judges whether or not the values of the new HCP area 54 in the records in which the same HLC is indicated by the values in the HLC name 53 match each other across all the apparatuses included in the multi-cluster system. Then, if it is judged that the values of the new HCP area 54 in the records in which the same HLC is indicated by the values in the HLC name 53 match each other across all the apparatuses included in the multi-cluster system, the version number adjustment unit 34 judges that the new version storage notifications have been received from all the apparatuses.

For example, in the example in FIG. 4, the version number adjustment unit 34 judges whether all the records 56, 57, 58, 59, . . . , with a value “HLC01” in the HLC name 53 have an equal value in the new HCP area 54 (specifically, the value equal to “0102”, for example). Then, if all the records with the value “HLC01” in the HLC name 53 have the equal value in the new HCP area 54, the version number adjustment unit 34 judges that the new version storage notifications have been received from all the apparatuses.

In this connection, information indicating which HLC is a version-upgrade target HLC and the version number information of the new version of the HLC may be stored in a predetermined storage area in the disk 26 of the SVP 23 or the like. Instead, after storing the contents of the version number notifications into the HLC version number management information 37, the version number adjustment unit 34 may identify, as the version-upgrade target HLC, an HLC indicated by the HLC name in a record in which the new HCP area 54 and the old HCP area 55 have different values. In addition, the version number adjustment unit 34 may identify the version number information of the new version of an HLC indicated by the HLC name 53 by finding the latest value among the values of the new HCP area 54 in multiple records including the equal value in the HLC name 53.

On the other hand, if it is judged that the values in the new HCP area 54 in the records in which the same HLC is indicated by the values in the HLC name 53 do not match each other across all the apparatuses included in the multi-cluster system, the version number adjustment unit 34 judges that the new version storage notifications have not been received from all the apparatuses.

For example, in the example in FIG. 4, the version number adjustment unit 34 judges whether the records 56, 57, 58, 59, . . . , with the value “HLC01” in the HLC name 53 include at least one record which has a different value in the new HCP area 54. Specifically, for example, the version number adjustment unit 34 judges whether or not the records 56, 57, 58, 59, . . . , with the value “HLC01” in the HLC name 53 include even one record having a value other than “0102” in the new HCP area 54. Then, if the records with the value “HLC01” in the HLC name 53 include even one record which has the different value in the new HCP area 54, the version number adjustment unit 34 judges that the new version storage notifications have not been received from all the apparatuses.

If it is judged that the new version storage notifications have not been received from all the apparatuses, the version number adjustment unit 34 instructs the managed apparatuses 32 or the version number switch unit 35 of the managing apparatus 31 to operate with the version-upgrade target HLC in the old version. In some part of the following description, such a notification transmitted from the version number adjustment unit 34 to the managed apparatuses 32 and the version number switch unit 35 and specifying the version of an HLC to be loaded in each apparatus is referred to as an activation version number instruction. As for an HLC other than a version-upgrade target HLC, the HLC of the old-version HCP and the HLC of the new-version HCP have the same version number and therefore the version number does not have to be particularly specified in the activation version number instruction.

If it is judged that the new version storage notifications have been received from all the apparatuses included in the multi-cluster system, the version number adjustment unit 34 transmits a version number switch instruction for the HLC to the version number switch unit 35 of the managing apparatus 31 or the managed apparatuses 32. Here, the version number switch instruction is transmitted to the apparatus to which the activation version number instruction to operate with the HLC in the old version was transmitted previously. The apparatus that has received the version number switch instruction terminates the HLC operated in the old version, and loads the new-version HLC.

Moreover, the version number adjustment unit 34 receives an HLC version number switch completion notification from the version number switch unit 35 or each managed apparatus 32. The HLC version number switch completion notification is a notification that each of the managed apparatuses 32 and the version number switch unit 35 of the managing apparatus 31 transmits when completing HLC version number switch processing.

Here, the HLC version number switch completion notification may include information on whether or not the HLC version number switch processing is successfully completed. When receiving a completion notification indicating a failure of the version number switch, the version number adjustment unit 34 may send again the version number switch unit 35 and each managed apparatus 32 a HCP (and HLCs) switch instruction to operate with the old-version HCP.

When receiving the HLC version number switch completion notifications from all the apparatuses to which the version number switch instructions have been transmitted, the version number adjustment unit 34 transmits the activation version number instruction to load the new-version HLC to an apparatus to which the version number switch instruction has not been transmitted yet. The apparatus to which the version number switch instruction has not been transmitted yet is the last apparatus in the multi-cluster system, from which the version number adjustment unit 34 lastly receives the new version storage notification.

Here, an activation version number instruction to directly activate the new-version HCP is transmitted to the last apparatus in the multi-cluster system from which the version number adjustment unit 34 lastly receives the new version storage notification. In other words, the last apparatus from which the version number adjustment unit 34 lastly receives the new version storage notification can omit activation of the old-version HCP, and the following version number switch processing. If another apparatus fails the HCP switching, an activation version number instruction to operate with the old-version HCP is transmitted to the last apparatus, and thereby the last apparatus can omit work to restore the HCP from the new version to the old version.

Moreover, the switch instruction may include an instruction to start the switch processing when a specified time point arrives. Each apparatus having received such switch instruction is controlled to start the switch processing at the specified time point. In addition, the apparatuses may be controlled to start processing using a new HLC after confirming that the HLC has been switched successfully in all the apparatuses.

Next, the version number switch unit 35 is explained. The version number switch unit 35 sends the version number adjustment unit 34 the version number notification including the version number information of the new-version HCP and HLCs stored in the new HCP area 40. This version number notification also has a meaning to inquire of the version number adjustment unit 34 which one of the two versions of HLCs stored in the old HCP area 39 and the new HCP area 40 is to be loaded. For this reason, as a response to the version number notification, the version number switch unit 35 receives an activation version number instruction that specifies the version numbers of HLCs to be operated. Then, the version number switch unit 35 loads the HLCs in the versions specified in the activation version number instruction to the RAM 25, for example. The environment of the SVP 23 to which the HLCs are loaded can be said to be an environment where the loaded HLCs are executable. As for an HLC other than the version-upgrade target HLC (the HLC for which the version numbers of HLCs stored in the old HCP area 39 and the new HCP area 40 are the same), the version number switch unit 35 loads the HLC from the new HCP area 40. Here, the transmission of the version number notification may be executed as a part of initialization processing of the managing apparatus 31. If any of the apparatuses included in the multi-cluster system is not yet ready to switch to a new-version HLC, the activation version number instruction gives an instruction to load the old-version HLC. Instead, if all the apparatuses included in the multi-cluster system are ready to switch to the new-version HLC, the activation version number instruction gives an instruction to load the new-version HLC. When the activation of the HCP is completed, the version number switch unit 35 transmits an activation completion notification indicating the completion of the HCP activation to the version number adjustment unit 34. The activation completion notification includes information indicating which one of the old-version HLC and the new-version HLC is loaded for each HLC.

Moreover, In the case where the activation version number instruction gives an instruction to load the old-version HLCs, the version number switch unit 35 thereafter receives the switch instruction to switch to the new-version HLCs from the version number adjustment unit 34 when the version number adjustment unit 34 confirms that all the apparatuses have become switchable to the new version, for example. If receiving the switch instruction, the version number switch unit 35 performs the switch processing to the new-version HLC. Specifically, the version number switch unit 35 terminates the old-version HLCs previously loaded from the old HCP area 39 and loads the new-version HLCs installed in the new HCP area 40. To put it differently, this processing is switching from the environment where the old-version HLCs are executable to the environment where the new-version HLCs are executable. Then, the version number switch unit 35 newly sets up, as an old HCP area 39, an area which was the new HCP area 40 before the switching, and as a new HCP area 40, an area which was the old HCP area 39 before the switching. In addition, the version number switch unit 35 may copy the data of the HCP and HLCs stored in the newly-set old HCP area 39 to the newly-set new HCP area 40. This facilitates the work of installing the version-upgraded HCP on or the work of applying an update patch to the information in the new HCP area 40 in the next version-upgrade work.

In order not to perform the switch processing for a running HLC, the version number switch unit 35, when receiving a switch instruction, checks the execution status of a version-upgrade target HLC before starting the switch processing. Then, the version number switch unit 35 starts the switch processing after confirming that the version-upgrade target HLC is not running. The execution statuses of HLCs are managed by using HLC execution status information 38.

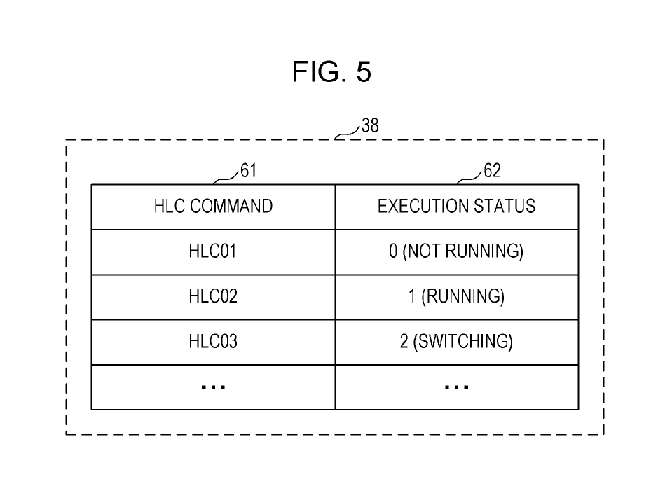

FIG. 5 illustrates one example of a data structure of the HLC execution status information 38. In FIG. 5, the HLC execution status information 38 includes data items of an HLC command 61 and an execution status 62. The data items of the HLC command 61 and the execution status 62 are associated with each other in each record. The HLC command 61 is identification information, such for example as an HLC name, which identifies each HLC of the HCP uniquely. The execution status 62 is information indicating the execution status of the associated HLC command. The execution status includes three statuses, namely, a not-running status, a running status and a switching status. The not-running status indicates that the associated HLC is not running. The running status indicates that the associated HLC is running, in other words, communications using the associated HLC is ongoing. The switching status indicates that the switch processing for the associated HLC is under execution.

The HLC execution status information 38 is stored in a predetermined storage area of the memory 25 of the SVP 23 or the like. In reference to the HLC execution status information 38, the version number switch unit 35 having received the switch instruction confirms whether the HLC is running or not. Specifically, the version number switch unit 35 checks whether the value in the field of the execution status 62 associated with the HLC command 61 in the HLC execution status information 38 is a value indicating the not-running status, and judges that the HLC is not running if the value in the field of the execution status 62 is the value indicating the not-running status. On the other hand, the version number switch unit 35 judges that the HLC is running if the value in the field of the execution status 62 is a value indicating the running status or the switching status.

If judging that the HLC is not running, the version number switch unit 35 starts the switch processing for the HLC command judged as not running. If judging that the HLC is running, the version number switch unit 35 waits until the running HLC is turned into the not-running status, and then starts the switch processing after confirming that the HLC is in the not-running status based on the HLC execution status information 38.

When the HLC switch processing is completed, the version number switch unit 35 transmits a notification of the completion of the HLC switch processing to the version number adjustment unit 34.

The HLC execution control unit 36 performs communications with multiple apparatuses included in the multi-cluster system by using HLCs. In addition, the HLC execution control unit 36 updates the HLC execution status information 38 depending on the use statuses of the HLCs. Specifically, when an HLC command indicated by the HLC command 61 in the HLC execution status information 38 is not running, the HLC execution control unit 36 sets the value indicating “not-running” in the associated field of the execution status 62. Or, if the HLC command indicated by the HLC command 61 is running, the HLC execution control unit 36 sets the value indicating “running” in the associated field of the execution status 62. Then, if the HLC command indicated by the HLC command 61 is switching, the HLC execution control unit 36 sets the value indicating “switching” in the associated field of the execution status 62. Here, when the HLC is in the “switching” status, the HLC execution control unit 36 sets the busy status in the availability of the scheduler execution right (the right to execute configuration control) to an instruction from the OS, and requests the OS to retry the instruction. In this way, a failure that would occur due to a competition with an instruction from the OS can be reduced.

The version number adjustment unit 34 is one example of the receiver unit 1 and the instruction unit 2. The version number switch unit 35 is one example of the transmitter unit 5 and the switch unit 6. The old HCP area 39 is one example of the first storage unit 3. The new HCP area 40 is one example of the second storage unit 4.

The managed apparatus 32 includes an HCP storage unit 41, a version number switch unit 42, and an HLC execution control unit 43.

The HCP storage unit 41 is the same as or similar to the HCP storage unit 33 in the managing apparatus 31.

The version number switch unit 42 transmits a version number notification to the version number adjustment unit 34 in the managing apparatus 31, the version number notification including the version number information of the new-version HCP and HLCs stored in the new HCP area 46. This version number notification also has a meaning to inquire of the version number adjustment unit 34 which one of the two versions of HLCs stored in the old HCP area 45 and the new HCP area 46 is to be loaded. For this reason, as a response to the version number notification, the version number switch unit 42 receives an activation version number instruction in which the version numbers of HLCs to be operated are specified. Then, the version number switch unit 42 loads the HLCs in the versions specified in the activation version number instruction to the RAM 25, for example. The environment of the SVP 23 in which the HLCs are loaded can be said to be an environment where the loaded HLCs are executable. As for an HLC (HLC for which the HLCs in the same version number are stored in the old HCP area 45 and the new HCP area 46) other than the version-upgrade target HLC, the version number switch unit 35 loads the HLC from the new HCP area 46. Here, the transmission of the version number notification may be executed as a part of initialization processing of the managed apparatus 32. If any of the apparatuses included in the multi-cluster system is not yet ready to switch to a new-version HLC, the activation version number instruction gives an instruction to load the old-version HLC. Instead, if all the apparatuses included in the multi-cluster system are ready to switch to the new-version HLC, the activation version number instruction gives an instruction to load the new-version HLC. When the activation of the HCP is completed, the version number switch unit 42 transmits an activation completion notification indicating the completion of the HCP activation to the version number adjustment unit 34 in the managing apparatus 31.

Moreover, in the case of receiving an activation version number instruction to load the old-version HLCs, the version number switch unit 42 thereafter receives the switch instruction to switch to the new-version HLCs from the version number adjustment unit 34 of the managing apparatus 31 when it is confirmed that all the apparatuses have become switchable to the new version, for example. If receiving the switch instruction, the version number switch unit 42 performs the switch processing to the new-version HLCs. Specifically, the version number switch unit 42 terminates the old-version HLCs previously loaded from the old HCP area 45 and loads the new-version HLCs installed in the new HCP area 46. To put it differently, in this processing, the version number switch unit 42 switches the environment where the old-version HLCs are executable to the environment where the new-version HLCs are executable. Then, the version number switch unit 42 newly sets up, as an old HCP area 45, an area which was the new HCP area 46 before the switching, and as a new HCP area 46, an area which was the old HCP area 45 before the switching. In addition, the version number switch unit 42 may copy the data of the HCP and HLCs stored in the newly-set old HCP area 45 to the newly-set new HCP area 46. This facilitates the work of installing the version-upgraded HCP on the information in the new HCP area 46 in the next version-upgrade work.

In the case of receiving the switch instruction, the version number switch unit 42 confirms the execution status of each HLC before the switch processing for the HLC. After confirming that the HLC is not running, the version number switch unit 42 starts the switch processing for the HLC. The execution statuses of HLCs are managed by using HLC execution status information 38. The HLC execution status information 38 is the same as or similar to that described using FIG. 5.

The HLC execution status information 38 is stored in a predetermined storage area of the memory 25 of the SVP 23 or the like. In reference to the HLC execution status information 38, the version number switch unit 42 having received the switch instruction confirms whether the HLC is running or not. Specifically, the version number switch unit 42 checks whether the value in the field of the execution status 62 associated with the HLC command 61 in the HLC execution status information 38 is a value indicating the not-running status, and judges that the HLC is not running if the value in the field of the execution status 62 is the value indicating the not-running status. On the other hand, the version number switch unit 42 judges that the HLC is running if the value in the field of the execution status 62 is a value indicating the running status or the switching status.

If judging that the HLC is not running, the version number switch unit 42 starts the switch processing for the HLC command judged as not running.

If judging that the HLC is running, the version number switch unit 42 waits until the running HLC is turned into the not-running status, and then starts the switch processing after confirming that the HLC is in the not-running status based on the HLC execution status information 38. When the HLC switch processing is completed, the version number switch unit 42 transmits a notification of the completion of the HLC switch processing to the version number adjustment unit 34 in the managing apparatus 31.

The HLC execution control unit 43 is the same as or similar to the HLC execution control unit 36 in the managing apparatus 31.

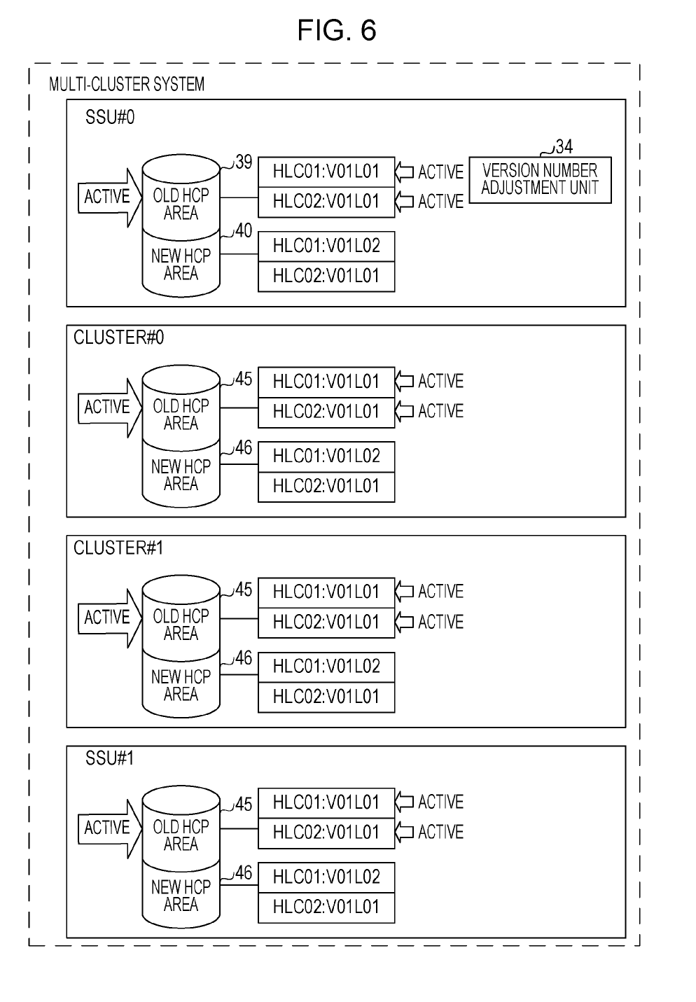

Next, an execution of a HCP version-upgrade in the multi-cluster system according to the present embodiment is described in reference to FIGS. 6 to 9. FIG. 6 illustrates one example of a state before a version-upgrade in the multi-cluster system according to the present embodiment.

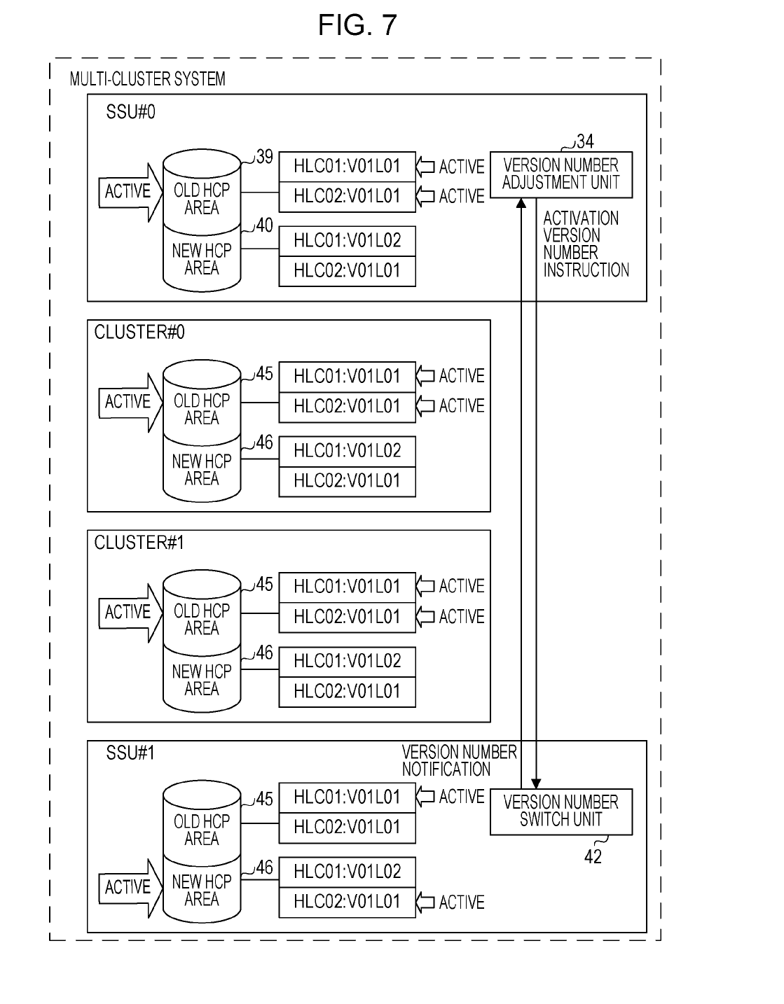

In FIG. 6, the multi-cluster system includes the SSU#0, the cluster#0, the cluster#1 and the SSU#1. The SSU#0 is one example of the managing apparatus 31, whereas the cluster#0, the cluster#1 and the SSU#1 are examples of the managed apparatuses 32. Then, in every apparatus, the old-version HCP and HLCs stored in the old HCP area 45 are running. In addition, the new HCP area 46 is in a state where the installation work of the new-version HCP is already completed. More specifically, in the old HCP area 45 in every apparatus, the HCP in a version number of “E90L01G 01B+020”, an HLC “HLC01” in a version number “V01L01” and an HLC “HLC02” in the version number “V01L01” are stored. In the new HCP area 46 in every apparatus, the HCP in a version number of “E90L01G 01B+070”, the HLC “HLC01” in a version number “V01L02” and the HLC “HLC02” in the version number “V01L01” are stored. Here, it is assumed that the version number adjustment unit 34 in the managing apparatus 31 has not received yet the version number notification from any of the version number switch units 42 of the apparatuses by this time. In reference to FIGS. 7 to 9, description is provided below for an example in which activation processing for the new-version HCP starts from the above state and is performed by the apparatuses sequentially in the order of the SSU#1, the SSU#0, the cluster#1 and the cluster#0. For the sake of description, it is assumed herein that the new HCP area is in the state where the installation work of the new-version HCP is already completed. However, the installation work of the new-version HCP in the new HCP area only has to be completed before the transmission of the version number notification to the managing apparatus 31.

FIG. 7 is a diagram for explaining an execution performed when the SSU#1 activates the new-version HCP from the state presented in FIG. 6.

In FIG. 7, the version number switch unit 42 of the SSU#1 transmits a version number notification to the version number adjustment unit 34 in the SSU#0 functioning as the managing apparatus 31. The version number notification includes the version number information of the new-version HCP and HLCs stored in the new HCP area 46 in the SSU#1. This version number notification also has a meaning to inquire which one of the two versions of HLCs stored in the old HCP area 45 and the new HCP area 46 is to be loaded. Specifically, in the version number notification, the version number switch unit 42 in the SSU#1 notifies that the HCP of “E90L01G 01B+070”, the HLC “HLC01” in the version number “V01L02” and the HLC “HLC02” in the version number “V01L01” are stored in the new HCP area 46 in the SSU#1. Note that this version number notification is a new version storage notification because the notification is information indicating that the new-version HCP (and HLC) is stored in the new HCP area 46.

Next, the version number adjustment unit 34 in the SSU#0 having received the version number notification from the SSU#1 stores the contents of the received version number notification into the HLC version number management information 37. Specifically, in the HLC version number management information 37 in FIG. 4, for example, the version number adjustment unit 34 firstly updates the value of the HCP version number 52 to “E90L01G 01B+070” in the record with “SSU#1” in the apparatus name 51. Then, the version number adjustment unit 34 stores the values “V01L02” and “V01L01” into the fields of the new HCP area 54 in the records with “SSU#1” in the apparatus name 51 and “HLC01” and “HLC02” in the HLC name 53, respectively.

Then, the version number adjustment unit 34 determines that version numbers of the HLCs to be operated in the SSU#1 based on the HLC version number management information 37, and transmits the activation version number instruction indicating the determined version numbers to the SSU#1. In the determination of the version numbers of the HLCs to be operated in the SSU#1, specifically, the version number adjustment unit 34 firstly judges whether or not the new version storage notifications have been received from all the apparatuses included in the multi-cluster system. To be more specific, in reference to the HLC version number management information 37, the version number adjustment unit 34 judges whether or not the values in the new HCP area 54 in the records in which the same HLC is indicated by the values in the HLC name 53 match each other across all the apparatuses included in the multi-cluster system. Note that the records of a version-upgrade target HLC are records associated with an HLC whose version is different between the new-version HCP and the old-version HCP. Specifically, the version number adjustment unit 34 judges whether or not all the records with “HLC01” in the HLC name 53 in the HLC version number management information 37 have an equal value in the new HCP area 54. At this time, the version number adjustment unit 34 may judge whether or not the values in the new HCP area 54 in all the records with “HLC01” in the HLC name 53 in the HLC version number management information 37 are equal to “V01L02” which is the version number of the new version. In this case, since the values in the new HCP area 54 associated with the apparatuses other than the SSU#1 in the records with “HLC01” in the HLC name 53 are not “V01L02,” the version number adjustment unit 34 judges that the new version storage notifications have not been received from all the apparatuses. As a result, the version number adjustment unit 34 determines that the version number of the HLC “HLC01” to be operated in the SSU#1 is “V01L01” of the old version.

Then, the version number adjustment unit 34 sends the SSU #1 an activation version number instruction in which the HLC “HLC01” to be operated is specified as the old version “V01L01”. In the activation version number instruction, the version number adjustment unit 34 does not have to particularly specify the version number of “HLC02” which is not the version-upgrade target HLC.

Subsequently, when receiving the activation version number instruction from the SSU#0, the version number switch unit 42 of the SSU#1 loads the HLCs of the version numbers specified in the activation version number instruction. Specifically, for “HLC01”, the version number switch unit 42 loads “HLC01” in the version number “V01L01” stored in the old HCP area 45. For “HLC02” which is not the version-upgrade target HLC, the version number switch unit 42 loads “HLC02” from the new HCP area 46. FIG. 7 presents that the SSU#1 operates “HLC01” in the old HCP area 45 and “HLC02” in the new HCP area 46.

Then, the SSU#1 continues the activation processing of the new-version HCP after HLC loading.

In the same way as the SSU#1, the SSU#0 and the cluster#1 perform the activation processing of the new-version HCP.

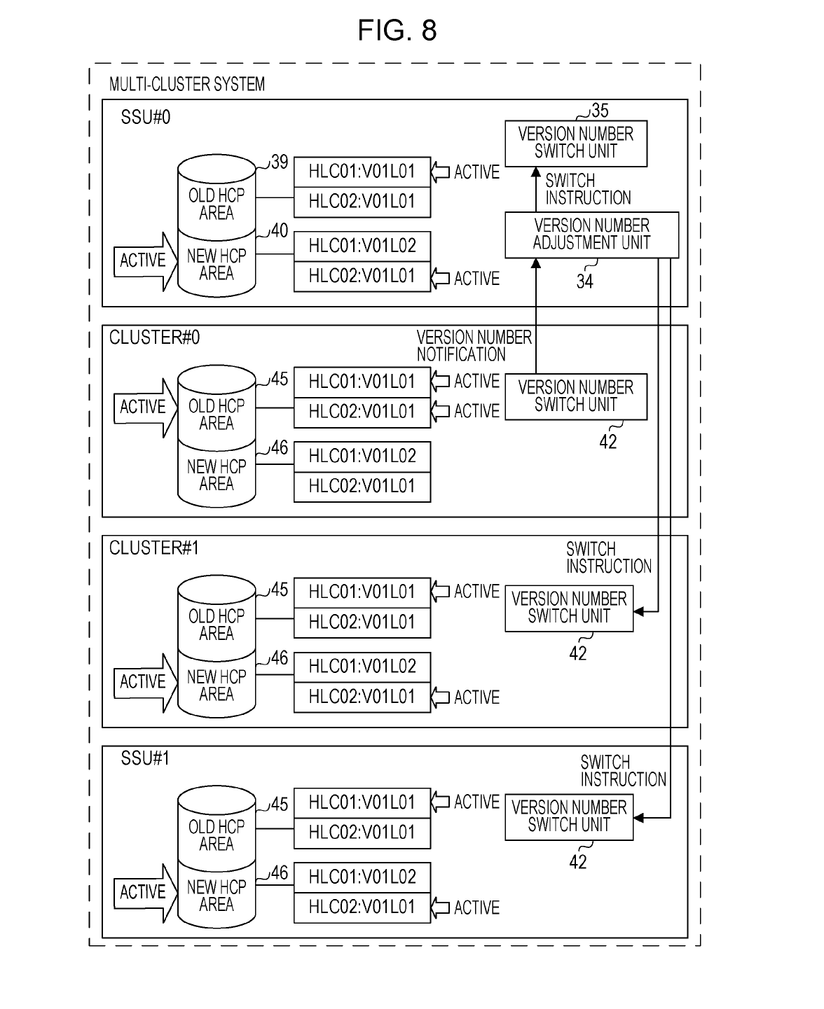

Lastly, the cluster#0 performs the activation processing of the new-version HCP. FIG. 8 is a diagram for explaining an execution of the activation processing of the new-version HCP in the cluster#0 after completion of the activation processing of the new-version HCP in the SSU#0 and the cluster#1. In FIG. 8, in the SSU#0, the SSU#1 and the cluster#1, “HLC01” in the version number “V01L01” stored in the old HCP areas 39, 45 and “HLC02” stored in the new HCP areas 40, 46 are in operation. In FIG. 8, the cluster#0 is an apparatus from which the version number notification transmitted in the activation processing of the new-version HCP is received by the version number adjustment unit 34 lastly among the apparatuses in the multi-cluster system.

In FIG. 8, the version number switch unit 42 in the cluster#0 sends the version number adjustment unit 34 in the SSU#0 the version number notification including the version number information of the new-version HCP and HLCs stored in the new HCP area 46 in the cluster#0. This version number notification also has a meaning to inquire which one of the two HLCs stored in the old HCP area 45 and the new HCP area 46 is to be operated. Specifically, in the version number notification, the version number switch unit 42 in the cluster#0 notifies that the HCP of “E90L01G 01B+070”, the HLC “HLC01” in the version number “V01L02” and the HLC “HLC02” in the version number “V01L01” are stored in the new HCP area 46 in the cluster#0. Note that this version number notification is a new version storage notification because the notification is information indicating that the new-version HCP is stored in the new HCP area 46.

Next, the version number adjustment unit 34 in the SSU#0 having received the version number notification from the cluster#0 stores the contents of the received version number notification into the HLC version number management information 37. Specifically, in the HLC version number management information 37 in FIG. 4, for example, the version number adjustment unit 34 firstly updates the value of the HCP version number 52 to “E90L01G 01B+070” in the records with “cluster#0” in the apparatus name 51. Then, the version number adjustment unit 34 stores the values of “V01L02” and “V01L01” into the fields of the new HCP area 54 in the records with “cluster#0” in the apparatus name 51 and with “HLC01” and “HLC02” in the HLC name 53, respectively.

Here, after the version number adjustment unit 34 stores the contents of the notification from cluster#0 into the HLC version number management information 37, the records associated with the version-upgrade target HLC have the values equal to the value indicting the new version in the fields of the new HCP area 54 associated with all the apparatuses. To put it differently, in all the records with “HLC01” in the HLC name 53 in the HLC version number management information 37, the values in the fields of the new HCP area 54 are “V01L02” indicating the new version.

After storing the contents of the version number notification into the HLC version number management information 37, the version number adjustment unit 34 judges whether or not the new version storage notifications have been received from all the apparatuses included in the multi-cluster system. To be more specific, in reference to the HLC version number management information 37, the version number adjustment unit 34 judges whether the values in the new HCP area 54 of the records in which the same HLC is indicated by the values in the HLC name 53 match each other across all the apparatuses included in the multi-cluster system. The records of a version-upgrade target HLC are records associated with an HLC whose version is different between the new-version HCP and the old-version HCP. Specifically, the version number adjustment unit 34 judges whether or not all the records with “HLC01” in the HLC name 53 in the HLC version number management information 37 have an equal value in the new HCP area 54. At this time, the version number adjustment unit 34 may judge whether or not the values in the new HCP area 54 in all the records with “HLC01” in the HLC name 53 in the HLC version number management information 37 are equal to “V01L02” which is the version number of the new version. In this case, since the values in the new HCP area 54 in all the records with “HLC01” in the HLC name 53 are “V01L02”, the version number adjustment unit 34 judges that the new version storage notifications have been received from all the apparatuses.

If judging that the new version storage notifications have been received from all the apparatuses, the version number adjustment unit 34 sends a switch instruction to switch to the new-version HLC. In the transmission of the switch instruction, the version number adjustment unit 34 transmits the switch instruction to all the apparatuses included in the multi-cluster system (and the version number switch unit 35 of the managing apparatus 31), except for the apparatus that has transmitted the new version storage notification lastly received among the received notifications. Specifically, the version number adjustment unit 34 transmits the switch instruction to the version number switch units 42 in the SSU#1 and the cluster#1 and the version number switch unit 35 in the SSU#0.

The version number switch units of the apparatuses having received the switch instruction to switch to the new-version HLC, namely, the version number switch units 42 in the SSU#1 and the cluster#1 and the version number switch unit 35 in the SSU#0 each check the execution status of the version-upgrade target HLC that is in operation in the old version. Specifically, the version number switch unit 35, 42 in each of the apparatuses having received the switch instruction firstly refers to the value in the field of the execution status 62 in the record having “HLC01” as the value of the HLC command 61 in the HLC execution status information 38. If the referred value of the execution status 62 indicates “not-running”, the version number switch unit 35, 42 judges that “HLC01” is not running. If the referred value of the execution status 62 indicates “running” or “switching”, the version number switch unit 35, 42 judges that “HLC01” is running.

If judging that the old-version HLC is running in the checking of the execution status of the version-upgrade target HLC, the version number switch unit 35, 42 waits until the running HLC is turned into the not-running status. The version number switch unit 35, 42 continues checking the execution status by monitoring the HLC execution status information 38 through polling or the like, for example, until the version-upgrade target HLC is judged as not running.

Then, if judging that the version-upgrade target HLC is not running in the checking of the execution status of the HLC, the version number switch unit 35, 42 in each apparatus having received the switch instruction terminates the version-upgrade target HLC in the old version, and loads the new-version HLC. Specifically, the version number switch unit 35, 42 in each apparatus having received the switch instruction terminates “HLC01” in the old version of “V01L01” and loads “HLC01” in the version number “V01L02” from the new HCP area 46.

When completing the loading of the new-version HLC, the version number switch unit 35, 42 in each apparatus having received the switch instruction sends the version number adjustment unit 34 in the managing apparatus 31 a switch completion notification indicating the completion of the HLC switching. Specifically, when completing the loading of “HLC01” in the version number “V01L02”, the version number switch units 42 in the SSU#1 and the cluster#1 and the version number switch unit 35 in the SSU#0 transmit the switch completion notifications to the SSU#0.

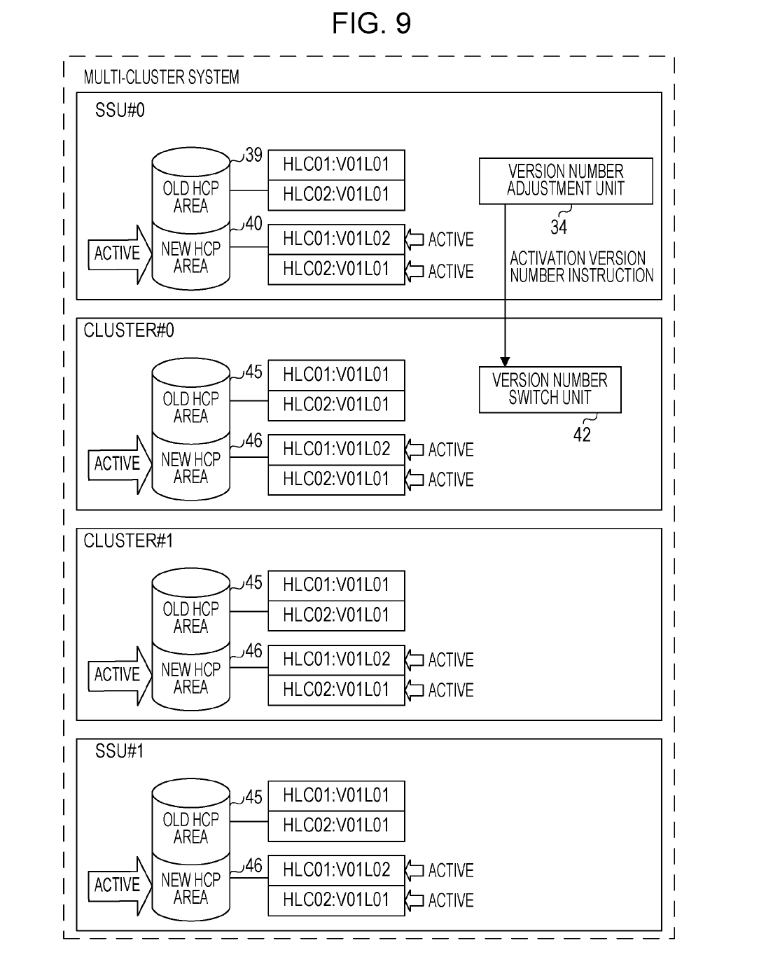

Next, the version number adjustment unit 34 of the managing apparatus 31 receives the switch completion notifications from the apparatuses to which the switch instructions have been transmitted. FIG. 9 is a diagram for explaining an operation in activating the new-version HCP in the cluster#0 from the state where the switch completion notifications are received from all the apparatuses to which the switch instructions have been transmitted. In FIG. 9, “HLC01” in the version number “V01L02” stored in the new HCP area 46 is in operation in the SSU#0, the SSU#1, and the cluster#1.

In this state, the version number adjustment unit 34 transmits an activation version number instruction in which the version number of the HLC to be operated is specified as the version number of the new version, to the apparatus (or the version number switch unit 35) that has transmitted the last one of the received new version storage notifications. Specifically, the version number adjustment unit 34 sends the cluster#0 the activation version number instruction in which the version number of “HLC01” to be operated is specified as “V01L02”.

When receiving the activation version number instruction, the version number switch unit 35 of the cluster#0 loads the HLC “HLC01” and the HLC “HLC02” in the version numbers of “V01L02” and “V01L01”, respectively, stored in the new HCP area 46 based on the content in the activation version number instruction. Then, the cluster#0 continues the activation processing of the new-version HCP.

When the cluster#0 completes the activation processing of the new-version HCP, the cluster#0 transmits the activation completion notification indicating the completion of the activation to the version number adjustment unit 34 of the managing apparatus 31. Note that the version number switch unit 35 of the cluster#0 forms the activation completion notification including information indicating that the new-version HLC is loaded.

Thereafter, the version number adjustment unit 34 judges whether or not the version number switch completion notification or the activation completion notification including the information indicating that the new-version HLC is loaded has been received from each of the apparatuses included in the multi-cluster system. Then, if judging that the version number switch completion notification or the activation completion notification including the information indicating that the new-version HLC is loaded has been received from each of the apparatuses included in the multi-cluster system, the version number adjustment unit 34 performs the following operation. Specifically, in the HLC version number management information 37, the version number adjustment unit 34 stores the values of the new HCP area 54 into the fields of the old HCP area 55 of the corresponding records.

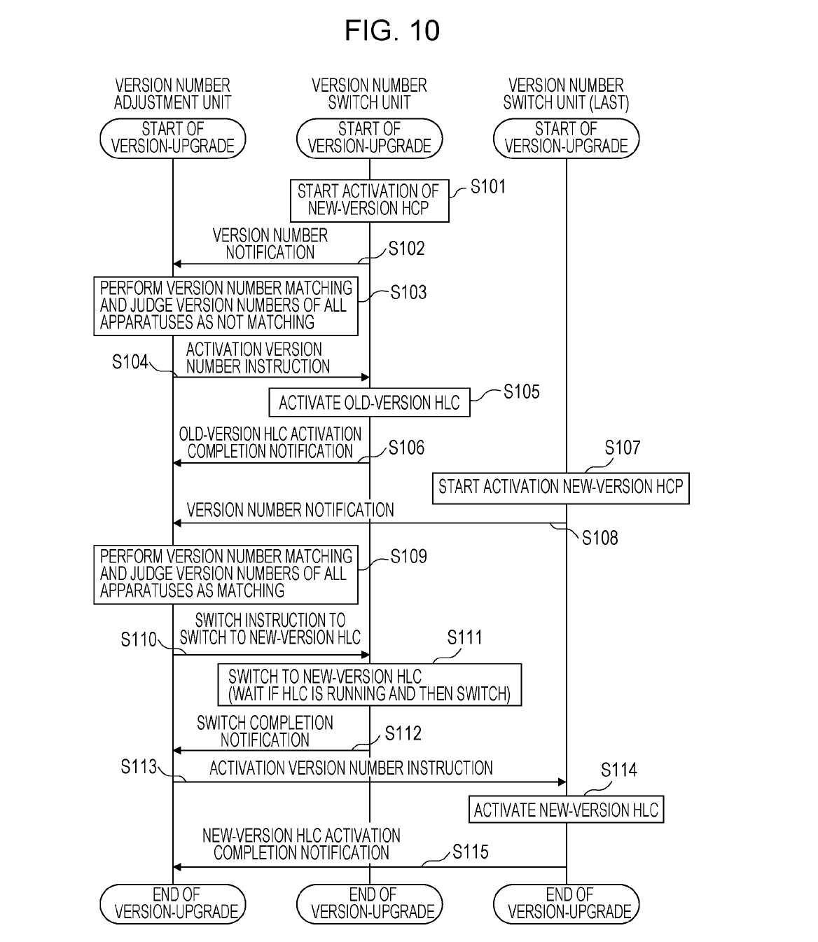

The version number switch processing in the present embodiment is executed as described above. Next, a version-upgrade processing flow is described by using flowcharts in FIGS. 10 to 12.

FIG. 10 is a flowchart illustrating processing contents of a version-upgrade in the entire multi-cluster system according to the present embodiment. In FIGS. 10 to 12, the version number switch unit of an apparatus from which the version number adjustment unit 34 lastly receives the new version storage notification is called a “version number switch unit (last)”, whereas the version number switch unit of an apparatus from which the version number adjustment unit 34 receives the new version storage notification which is not the last one is simply called a “version number switch unit”. Here, it is assumed that the new-version HCP is already stored in the new HCP areas 40, 46 in the apparatuses included in the multi-cluster system at a flow start time point in FIGS. 10 to 12. In addition, there is a case where the managing apparatus 31 lastly transmits the new version storage notification to the version number adjustment unit 34. In this case, processing of the version number switch unit (last) in FIGS. 10 to 12 is performed by the version number switch unit 35 of the managing apparatus 31.

In FIG. 10, the version number switch unit 35, 42 firstly starts an activation of the new-version HCP from the new HCP area 40, 46 (S101). Then, in the initialization processing of the new-version HCP, the version number switch unit 35, 42 transmits the version number notification to the version number adjustment unit 34 of the managing apparatus 31 (S102). Note that, the version number notification transmitted in S102 is a new version storage notification because the notification is transmitted in the state where the new-version HCP is stored in the new HCP area 46.

When receiving the HLC version number notification (new version storage notification), the version number adjustment unit 34 judges whether or not the version numbers of HLCs stored in the new HCP areas in all the apparatuses included in the multi-cluster system match each other (S103). In other words, the version number adjustment unit 34 judges whether or not the version numbers in the version number information received from all the apparatuses included in the multi-cluster system match each other. If judging that any one of the version numbers in the version number information received from all the apparatuses included in the multi-cluster system does not match the others, the version number adjustment unit 34 sends the version number switch unit 35, 42 an activation version number instruction in which the HLC to be loaded is specified as the old-version HLC (S104).

When receiving the activation version number instruction, the version number switch unit 35, 42 loads the old-version HLC based on the received instruction (S105). Then, when completing the activation of the HCP, the version number switch unit 35, 42 sends the version number adjustment unit 34 a completion notification indicating that the activation of the HCP is completed (S106).

On the other hand, independently of S101 to S106, the version number switch unit (last) 35, 42 starts an activation of the new-version HCP (S107). Then, in the initialization processing of the new-version HCP, the version number switch unit (last) 35, 42 transmits the version number notification (new version storage notification) to the version number adjustment unit 34 (S108). Note that, in the switching process to switch to the new version, the new version storage notification of the version number switch unit (last) 35, 42 is the notification received by the version number adjustment unit 34 lastly among the new version storage notifications transmitted from the apparatuses included in the multi-cluster system.

When receiving the version number notification from the version number switch unit (last) 35, 42, the version number adjustment unit 34 judges whether or not the version numbers of the HLCs stored in the new HCP areas of all the apparatuses included in the multi-cluster system match each other (S109). In other words, the version number adjustment unit 34 judges whether or not the version numbers of the version number information received from all the apparatuses included in the multi-cluster system match each other. If judging that the version numbers in the version number information received from all the apparatuses included in the multi-cluster system match each other, the version number adjustment unit 34 transmits the switch instruction to switch to the new-version HLC to all the version number switch units 35, 42 except for the version number switch unit (last) 35, 42 (S110).

When receiving the switch instruction to switch to the new-version HLC, the version number switch unit 35, 42 performs the switch processing to switch to the new-version HLC (S111). Before the switch processing, the execution status of the version-upgrade target HLC is checked, and then the switch processing is started after it is confirmed that the HLC is not running. When completing the HLC switch processing, the version number switch unit 35, 42 sends the version number adjustment unit 34 the switch completion notification indicating that the switch processing to switch the new-version HLC is completed (S112).

When receiving the switch completion notifications from all the version number switch units 35, 42 except for the version number switch unit (last) 35, 42, the version number adjustment unit 34 transmits the activation version number instruction to the version number switch unit (last) 35, 42 (S113). This activation version number instruction designates the version number of the new version.

When receiving the activation version number instruction, the version number switch unit (last) 35, 42 loads the new-version HLC based on the received instruction (S114). When completing the activation of the new-version HCP, the version number switch unit (last) 35, 42 sends the version number adjustment unit 34 a completion notification indicating that the activation of the new-version HCP is completed (S115). Then, the version-upgrade processing is terminated.

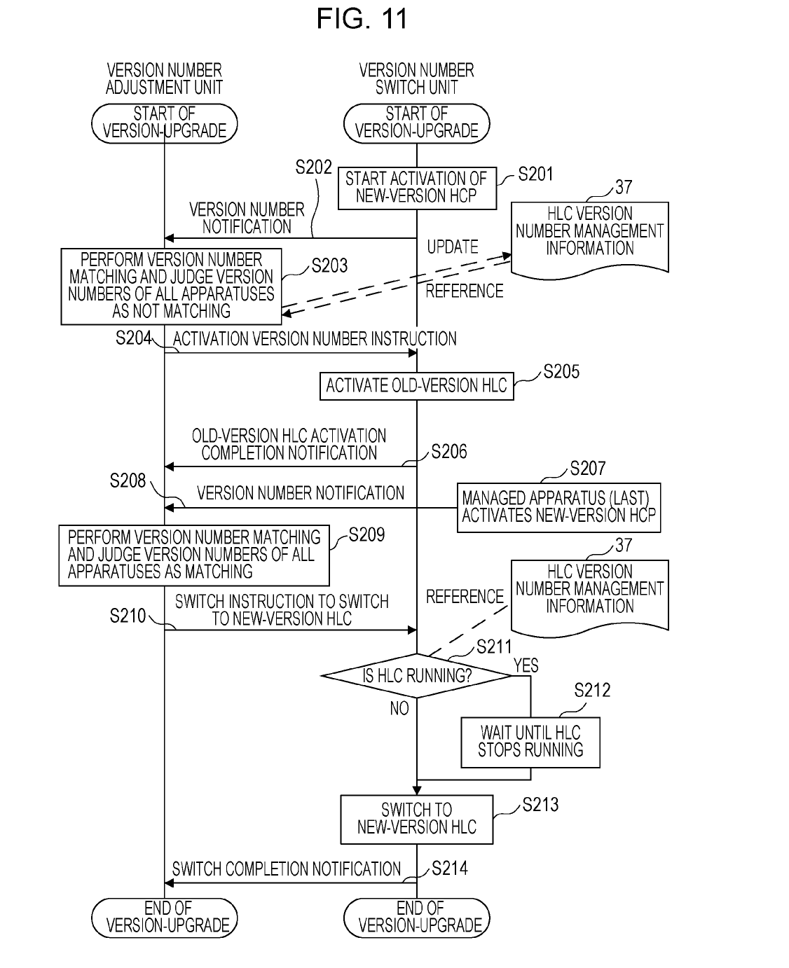

FIG. 11 is a flowchart illustrating detailed processing contents of a version-upgrade in the version number adjustment unit 34 and the version number switch unit 35, 42 in the multi-cluster system according to the present embodiment. It is assumed that the new-version HCP is already stored in the new HCP areas 40, 46 at a flow start time point in FIG. 11.

Firstly, the version number switch unit 35, 42 starts an activation of the new-version HCP (S201). Then, in the initialization processing of the new-version HCP, the version number switch unit 35, 42 transmits the HLC version number notification (new version storage notification) to the version number adjustment unit 34 (S202).

When receiving the HLC new version storage notification, the version number adjustment unit 34 of the managing apparatus 31 stores the contents of the received new version storage notification into the HLC version number management information 37. Then, in reference to the HLC version number management information 37, the version number adjustment unit 34 judges whether or not the values in the new HCP area 54 in the records in which the same HLC is indicated by the values in the HLC name 53 match each other across all the apparatuses included in the multi-cluster system (S203). If judging that the values do not match each other, the version number adjustment unit 34 sends the version number switch unit 35, 42 the activation version number instruction in which the HLC to be loaded is specified as the old-version HLC (S204).

When receiving the activation version number instruction, the version number switch unit 35, 42 loads the old-version HLC based on the received instruction (S205). Specifically, the version number switch unit 35, 42 loads the version-upgrade target HLC from the old HCP area 39, 45. In the meantime, the version number switch unit 35, 42 loads the HLC other than the version-upgrade target HLC from the new HCP area 40, 46. Then, when completing the activation of the HCP, the version number switch unit 35, 42 sends the version number adjustment unit 34 the completion notification indicating that the activation is completed (S206).

On the other hand, independently of S201 to S206, the version number switch unit (last) 35, 42 starts an activation of the new-version HCP (S207). Then, in the initialization processing of the new-version HCP, the version number switch unit (last) 35, 42 transmits the HLC version number notification (new version storage notification) to the version number adjustment unit 34 (S208). Note that the new version storage notification of the version number switch unit (last) 35, 42 is received by the version number adjustment unit 34 lastly among the new version storage notifications transmitted from the apparatuses included in the multi-cluster system.

When receiving the new version storage notification from the version number switch unit (last) 35, 42, the version number adjustment unit 34 stores the contents of the received new version storage notification into the HLC version number management information 37. Thereafter, in reference to the HLC version number management information 37, the version number adjustment unit 34 judges whether or not the values in the new HCP area 54 in the records in which the same HLC is indicated by the values in the HLC name 53 match each other across all the apparatuses included in the multi-cluster system (S209). Here, if judging that the values in the new HCP area 54 in the records in which the same HLC is indicated by the values in the HLC name 53 match each other across all the apparatuses included in the multi-cluster system, the version number adjustment unit 34 sends the version number switch unit 35, 42 the switch instruction to switch to the new-version HLC (S210).

When receiving the switch instruction to switch to the new-version HLC, the version number switch unit 35, 42 performs the switch processing to switch to the new-version HLC. Specifically, in reference to the HLC execution status information 38, the version number switch unit 35, 42 judges whether or not the version-upgrade target HLC is running (S211).

If judging that the version-upgrade target HLC is not running (No in S211), the processing advances to S213.

On the other hand, if judging in S211 that the version-upgrade target HLC is running (Yes in S211), the version number switch unit 35, 42 waits until the version-upgrade target HLC is judged as not running any more (S212). If judging that the version-upgrade target HLC is not running any more, the version number switch unit 35, 42 loads the version-upgrade target HLC in the new version from the new HCP area 40, 46 (S213). Then, the version number switch unit 35, 42 newly sets up an old HCP area 39, 45 at an area which was the new HCP area 40, 46 before the switching, and a new HCP area 40, 46 at an area which was the old HCP area 39, 45 before the switching. In addition, the version number switch unit 35, 42 may copy the data of the HCP and HLCs stored in the newly-set old HCP area 39, 45 to the newly-set new HCP area 40, 46.

When completing the switch processing to switch to the new-version HLC, the version number switch unit 35, 42 sends the version number adjustment unit 34 the switch completion notification indicating that the switch processing to switch to the new-version HLC is completed (S214). Then, the version-upgrade processing in the version number switch unit 35, 42 is terminated.

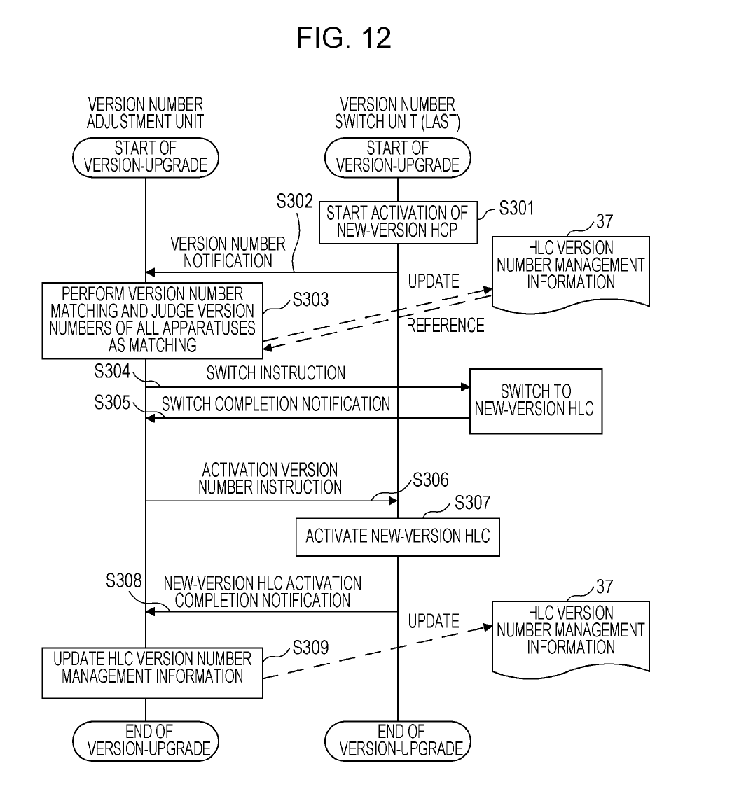

FIG. 12 is a flowchart illustrating detailed processing contents of a version-upgrade in the version number adjustment unit 34 of the managing apparatus 31 and the version number switch unit (last) 35, 42 in the multi-cluster system according to the present embodiment. It is assumed that the new-version HCP is already stored in the new HCP area 40, 46 in the version number switch unit (last) 35, 42 at a flow start time point in FIG. 12.

Firstly, the version number switch unit (last) 35, 42 starts an activation of the new-version HCP from the new HCP area 40, 46 (S301). Then, in the initialization processing of the new-version HCP, the version number switch unit (last) 35, 42 transmits the HLC version number notification (new version storage notification) to the version number adjustment unit 34 (S302).

When receiving the new version storage notification from the version number switch unit (last) 35, 42, the version number adjustment unit 34 of the managing apparatus 31 stores the contents of the received new version storage notification into the HLC version number management information 37. Then, in reference to the HLC version number management information 37, the version number adjustment unit 34 judges whether or not the values in the new HCP area 54 in the records in which the same HLC is indicated by the values in the HLC name 53 match each other across all the apparatuses included in the multi-cluster system (S303). Here, if judging that the values in the new HCP area 54 in the records in which the same HLC is indicated by the values in the HLC name 53 match each other across all the apparatuses included in the multi-cluster system, the version number adjustment unit 34 sends the version number switch unit 35, 42 the switch instruction to switch to the new-version HLC (S304).

When receiving the switch instruction to switch to the new-version HLC, the version number switch unit 35, 42 performs the switch processing to switch to the new-version HLC. Then, when completing the switch processing to switch to the new-version HLC, the version number switch unit 35, 42 sends the version number adjustment unit 34 the switch completion notification indicating that the switch processing to switch to the new-version HLC is completed (S305).

When receiving the switch completion notifications from all the version number switch units 35, 42 except for the version number switch unit (last) 35, 42, the managing apparatus 31 sends the activation version number instruction to the version number switch unit (last) 35, 42 (S306). This activation version number instruction designates the version number of the new version.

When receiving the activation version number instruction, the version number switch unit (last) 35, 42 loads the new-version HLC based on the received instruction (S307). Then, the version number switch unit (last) 35, 42 newly sets up an old HCP area 39, 45 at an area which was the new HCP area 40, 46 before the switching, and a new HCP area 40, 46 at an area which was the old HCP area 39, 45 before the switching. In addition, the version number switch unit (last) 35, 42 may copy the data of the HCP and HLCs stored in the newly-set old HCP area 39, 45 to the newly-set new HCP area 40, 46.

Then, the version number switch unit (last) 35, 42 sends the version number adjustment unit the activation completion notification including information indicating that the new-version HLC is loaded (S308).

When receiving the activation completion notification including the information indicating that the new-version HLC is loaded from the version number switch unit (last) 35, 42, the version number adjustment unit 34 stores the values in the new HCP area 54 in the HLC version number management information 37 into the corresponding fields of the old HCP area 55 (S309). Specifically, the version number adjustment unit 34 judges whether or not the version number switch completion notification or the activation completion notification including the information indicating that the new-version HLC is loaded has been received from each of the apparatuses included in the multi-cluster system. Here, the version number adjustment unit 34 judges that the version number switch completion notification or the activation completion notification including the information indicating that the new-version HLC is loaded has been received from each of the apparatuses included in the multi-cluster system. Then, the version number adjustment unit 34 stores the values in the new HCP area 54 in the HLC version number management information 37 into the fields of the old HCP area 55 in the corresponding records. Then, the version-upgrade processing in the version number adjustment unit 34 and the version number switch unit (last) 35, 42 is completed.

In the flows in FIGS. 10 to 12, it is assumed that the installation work of the new-version HCP to the new HCP area is already completed at the flow start time point. However, the installation work of the new-version HCP to the new HCP area may be performed at any predetermined timing. In this case, after the completion of the installation work of the new-version HCP to the new HCP area, the version number notification is transmitted to the managing apparatus 31.

Note that the embodiments discussed herein are not to be limited to the above ones, but may be altered to have various configurations or implementation modes without departing from the spirit of the embodiments.

In addition, part of the SVP 23 in the embodiments may be implemented by hardware. Alternatively, the SVP 23 in the embodiments may be implemented by a combination of software and hardware.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus that is any one of a first information processing apparatus and a plurality of second information processing apparatuses included in a multi-cluster system in which the second information processing apparatuses are connected to the first information processing apparatus including a shareable storage device, comprising:
a receiver unit configured to receive version number information from the first information processing apparatus and the second information processing apparatuses in each of which a first execution environment where a first program is executable is effective, the version number information indicating a version number of a second program in a second execution environment where the second program being a modified version of the first program is executable; and
an instruction unit configured to transmit a switch instruction to the first information processing apparatus and the second information processing apparatuses, the switch instruction giving an instruction to switch the first execution environment to the second execution environment, if the version numbers in the version number information received from all the first information processing apparatus and the second information processing apparatuses included in the multi-cluster system match each other.

2. The information processing apparatus according to claim 1, further comprising:
a first storage unit configured to store the first program;
a second storage unit configured to store the second program;
a transmitter unit configured to transmit the version number information to any of the first information processing apparatus and the second information processing apparatuses in the multi-cluster system; and
a switch unit configured to switch the first execution environment to the second execution environment when the switch instruction is received from any of the first information processing apparatus and the second information processing apparatuses in the multi-cluster system.

3. The information processing apparatus according to claim 2, wherein the switch unit switches the first execution environment to the second execution environment when the first program is not running.

4. An information processing method for any one of a first information processing apparatus and a plurality of second information processing apparatuses included in a multi-cluster system in which the second information processing apparatuses are connected to the first information processing apparatus including a shareable storage device, the method comprising:
receiving version number information from the first information processing apparatus and the second information processing apparatuses in each of which a first execution environment where a first program is executable is effective, the version number information indicating a version number of a second program in a second execution environment where the second program being a modified version of the first program is executable; and
transmitting a switch instruction to the first information processing apparatus and the second information processing apparatuses, the switch instruction giving an instruction to switch the first execution environment to the second execution environment, if the version numbers in the version number information received from all the first information processing apparatus and the second information processing apparatuses included in the multi-cluster system match each other.

5. A non-transitory storage medium that stores an information processing program for a multi-cluster system including a first information processing apparatus including a shareable storage device, and a plurality of second information processing apparatuses connected to the first information processing apparatus, the program causing any one of the first information processing apparatus and the second information processing apparatuses to:
receive version number information from the first information processing apparatus and the second information processing apparatuses in each of which a first execution environment where a first program is executable is effective, the version number information indicating a version number of a second program in a second execution environment where the second program being a modified version of the first program is executable; and
transmit a switch instruction to the first information processing apparatus and the second information processing apparatuses, the switch instruction giving an instruction to switch the first execution environment to the second execution environment, if the version numbers in the version number information received from all the first information processing apparatus and the second information processing apparatuses included in the multi-cluster system match each other.
